(19) United States
(12) Patent Application Publication
(10) Pub. No.: US 2024/0144030 A1
(43) Pub. Date: May 2, 2024

(54) METHODS AND APPARATUS TO MODIFY PRE-TRAINED MODELS TO APPLY NEURAL ARCHITECTURE SEARCH

(71) Applicant: Intel Corporation, Santa Clara, CA (US)

(72) Inventors: Juan Pablo Muñoz, Folsom, CA (US); Nilesh Jain, Portland, OR (US); Chaunté Lacewell, Hillsboro, OR (US); Alexander Kozlov, Nizhny Novgorod (RU); Nikolay Lyalyushkin, Balakhna (RU); Vasily Shamporov, Nizhny Novgorod (RU); Anastasia Senina, Nizhny Novgorod (RU)

(21) Appl. No.: 18/279,820

(22) PCT Filed: Jun. 8, 2022
(86) PCT No.: PCT/US2022/032721

§ 371 Date: Aug. 31, 2023

Related U.S. Application Data
(60) Provisional application No. 63/208,945, filed on Jun. 9, 2021.
(60) Provisional application No. 63/262,245, filed on Oct. 7, 2021.

(51) Int. Cl. G06N 3/0985

(52) U.S. Cl. CPC G06N 3/0985

(57) ABSTRACT

Methods, apparatus, systems, and articles of manufacture to modify pre-trained models to apply neural architecture search are disclosed. Example instructions, when executed, cause processor circuitry to at least access a pre-trained machine learning model, create a super-network based on the pre-trained machine learning model, create a plurality of subnetworks based on the super-network, and search the plurality of subnetworks to select a subnetwork.

### RELATED APPLICATIONS

This patent claims the benefit of U.S. Provisional Patent Application No. 63/262,245, which was filed on Oct. 7, 2021, and U.S. Provisional Patent Application No. 63/208,945, which was filed on Jun. 9, 2021. U.S. Provisional Patent Application No. 63/262,245 and U.S. Provisional Patent Application No. 63/208,945 are hereby incorporated herein by reference in their entireties. Priority to U.S. Provisional Patent Application No. 63/262,245 and U.S. Provisional Patent Application No. 63/208,945 is hereby claimed.

### FIELD OF THE DISCLOSURE

This disclosure relates generally to machine learning, and, more particularly, to methods and apparatus to modify pre-trained models and apply neural architecture search.

### BACKGROUND

Machine learning is an important enabling technology for the revolution currently underway in artificial intelligence, driving truly remarkable advances in fields such as object detection, image classification, speech recognition, natural language processing, and many more. Models are created using machine learning that, when utilized, enable an output to be generated based on an input.

The advent of Deep Learning has produced more accurate, and more complex models, while reducing the burden for human experts to perform hand-crafted feature engineering. Several frameworks have been developed to aid in the development of these pipelines (e.g., PyTorch and TensorFlow). However, Deep Learning architectures tend to be complex and designing good architectures is still an art. It is often the case that inexperienced ML practitioners must conform with well-known architectures as the base of their applications. Building machine learning (ML) pipelines often requires tedious work on pre-processing the data, choosing/designing the right algorithm, and the corresponding set of hyperparameters, among other steps. Many of these decisions vary depending on the application domain of the ML pipeline. These decisions can easily overwhelm machine learning enthusiasts, resulting in suboptimal choices.

### BRIEF DESCRIPTION OF THE DRAWINGS

FIG. 1 is a block diagram illustrating the use of an alternate model creator in accordance with teachings of this disclosure.

FIG. 2 is a block diagram of the example alternate model creator circuitry of FIG. 1 to modify pre-trained models to automatically generate super-networks and apply neural architecture search.

FIG. 3 is a flowchart representative of example machine readable instructions and/or example operations that may be executed and/or instantiated by processor circuitry to generate one or more alternate networks (subnets) based on a pre-trained model.

FIG. 4 is a diagram representing a situation in which a portion of a network is not used during inference.

FIG. 5 is a block diagram illustrating modifications applied to an example machine learning operation.

FIG. 6 is a flowchart representative of example machine readable instructions and/or example operations that may be executed and/or instantiated by processor circuitry to convert a static network to an elastic network.

FIG. 7 is a flowchart representative of example machine readable instructions and/or example operations that may be executed and/or instantiated by processor circuitry to perform fine tuning of inner structures of a super-network.

FIG. 8 is a block diagram representing application of elastic depth to an arbitrary super-network following application of progressive shrinking or another super-network training algorithm to remove blocks and generate sub-networks of different depth.

FIG. 9 is a flowchart representative of example machine readable instructions and/or example operations that may be executed and/or instantiated by processor circuitry to identify a subnetwork.

FIG. 10 is a graph illustrating performance characteristics of example sub-networks created using example approaches disclosed herein

FIG. 11 is a graph illustrating performance improvements of the example models illustrated in FIG. 10.

FIG. 12 is a block diagram of an example processing platform including processor circuitry structured to execute the example machine readable instructions and/or the example operations of FIGS. 3, 6, 7, and/or 9 to implement the example alternate model creator circuitry of FIG. 2.

FIG. 13 is a block diagram of an example implementation of the processor circuitry of FIG. 12.

FIG. 14 is a block diagram of another example implementation of the processor circuitry of FIG. 12.

FIG. 15 is a block diagram of an example software distribution platform (e.g., one or more servers) to distribute software (e.g., software corresponding to the example machine readable instructions of FIGS. 3, 6, 7, and/or 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

FIG. 16 illustrates an overview of an Edge cloud configuration for Edge computing.

FIG. 17 illustrates operational layers among endpoints, an Edge cloud, and cloud computing environments.

FIG. 18 illustrates an example approach for networking and services in an Edge computing system.

In general, the same reference numbers will be used throughout the drawing(s) and accompanying written description to refer to the same or like parts. The figures are not to scale.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description. As used herein “substantially real time” refers to occurrence in a near instantaneous manner recognizing there may be real world delays for computing time, transmission, etc. Thus, unless otherwise specified, “substantially real time” refers to real time+/−1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Building machine learning (ML) pipelines often requires tedious work on pre-processing the data, choosing/designing the right algorithm, and the corresponding set of hyperparameters, among other steps. Many of these decisions vary depending on the application domain of the ML pipeline. These decisions can easily overwhelm machine learning enthusiasts. Popular ML pipelines often use neural networks, which present opportunities for model compression with the goal of increasing their efficiency, and in some cases, also their accuracy. As a result, smaller compressed models can be deployed in resource-limited hardware satisfying the performance requirements of their applications. For example, smaller compressed models can be deployed for execution in Edge networks. Several frameworks have been developed to aid in the development of these pipelines. However, Deep Learning networks tend to be complex and designing good architectures is still an art. It is often the case that inexperienced ML practitioners have to conform with well-known architectures as the base for their models.

In the past few years, research in Neural Architecture Search (NAS) has captured the attention of experts in Deep Learning. NAS is a popular trend in AutoML, the collection of methods that explore different alternatives to building machine learning pipelines in an efficient and automated fashion. NAS solutions automate the design, training, and search of models that are more accurate and efficient than their human-engineered counterparts, obtaining more accurate and efficient architectures with minimal input (and effort) from a human expert. Given a search space, such as a set of standard and depthwise separable convolutions of varying sizes, cells/blocks of different lengths, and layers with multiple possible widths, a NAS algorithm finds one or more superior alternative architecture that improve significantly on a desirable aspect over the baseline model. For instance, the discovered alternative model might produce better accuracy while satisfying a set of computing and hardware efficiency requirements, such as lower latency/energy. In some cases, the resulting model can be further fine-tuned or compressed, for instance, by the application of a quantization algorithm. In other cases, developers might want to deploy the model right away without any further processing, hence significantly improving the time to deployment for the users.

Examples disclosed herein present an architecture named BootstrapNAS, an efficient NAS software framework implemented within the Neural Network Compression Framework (NNCF) for optimizing pre-trained models, resulting in a multitude of optimal subnetworks for a variety of hardware platforms. The goal of BootstrapNAS is to effectively democratize Machine Learning, allowing non-experts to further optimize their existing models, while easing the challenges that they encounter during this process. Such an architecture uses network morphism and weight sharing to automatically adapt and modify the given network (e.g., a machine learning model and/or a neural network) and produce a dynamic network, also referred to as a super-network and/or a one-shot network. As used herein, a super-network is a machine learning model and/or neural network that includes at least one dynamic parameter and/or property. This dynamic network has the weights from its static counterpart, and is suitable for the application of techniques for fine-tuning (e.g., training) its subnetworks (i.e., selected parts and/or combinations of parts of the main super-network). As disclosed herein, an example of a fine-tuning (e.g., training) procedure that has proven to be successful is Progressive Shrinking (PS). However, other training algorithms and/or procedures may additionally or alternatively be used.

In examples disclosed herein, static models, referred to herein as sub-networks, can be extracted from the dynamic network, and those sub-networks can be searched to identify variations of the original that meet various performance and/or operational requirements. As such, as used herein, a sub-network is a machine learning model and/or neural network that is derived from a super-network. In a similar manner as a biological taxonomy, a sub-network may correspond to a species, whereas a super-network may correspond to a taxonomical level at or above a genus level. In this manner, a super-network may allow for derivation of multiple different sub-networks.

Upon derivation and/or selection of a sub-network, the sub-network(s) can then be deployed for execution by a compute device (e.g., a compute node, an Edge device, etc.). In some examples, information (e.g., a file, metadata, a deployable artifact) corresponding to the selected sub-network may be deployed as well. In some examples, the selected sub-network and/or other non-selected sub-networks (and, in some examples, the super-network) may be deployed to multiple compute devices. In some examples, selection of the sub-network is based upon operational characteristics of the compute device(s) to which the sub-network is to be distributed. For example, if a compute device that is to execute the model had limited memory resources, a model that can be executed within those limited memory resources might be selected.

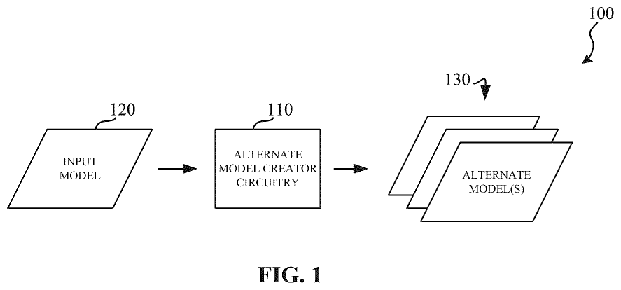

FIG. 1 is a block diagram illustrating the use of an alternate model creator 110 in accordance with teachings of this disclosure. The example alternate model creator 110 accesses an input model 120, and outputs one or more alternate models 130.

The example alternate model creator 110 of the illustrated example of FIG. 1 is implemented by a logic circuit such as, for example, a hardware processor that executes instructions. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), Coarse Grained Reduced precision architecture (CGRA(s)), image signal processor(s) (ISP(s)), etc.

Example approaches disclosed herein automate the process of taking a pre-trained model (e.g., the input model 120) and returning a set of models (e.g., the one or more alternate models 130) that outperform the original model. Examples disclosed herein automate the analysis and modification of the original architecture by the application of network morphism and producing an alternative, simplified model that is suitable for state-of-the-art optimization algorithms, (e.g., Progressive Shrinking), used as plug-ins in the example disclosed herein to fine-tune subnetworks. After a fine-tuning stage has taken place, the alternate model creator 110 produces a set of models, some of which are intended to outperform the provided pre-trained model.

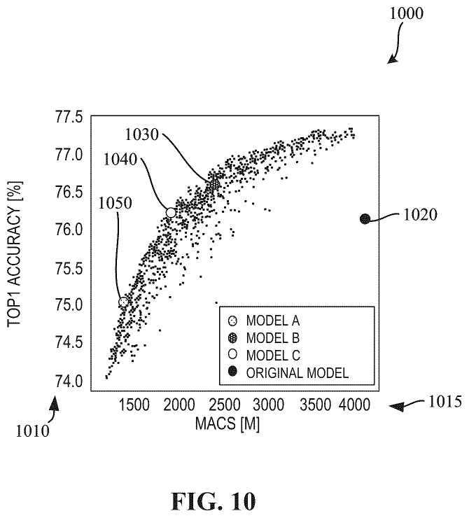

Examples disclosed herein decouple the optimization from a specific platform. In this manner, examples disclosed herein enable production of a set of optimized models for various computing platforms that are intended to execute the selected model. To do so, the alternate model creator 110 fine-tunes a set of subnetworks from an overparametrized super-network, where each subnetwork is meant to satisfy different accuracy and efficiency requirements. The final objective of the alternate model creator 110 is to return a subset of subnets that belong to the Pareto frontier (FIG. 10) of the space of subnetworks.

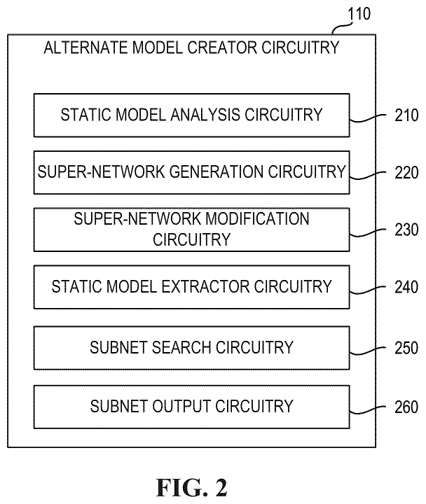

FIG. 2 is a block diagram of the example alternate model creator circuitry 110 of FIG. 1 to modify pre-trained models to apply neural architecture search. The example alternate model creator circuitry 110 of FIG. 2 may be instantiated (e.g., creating an instance of, bring into being for any length of time, materialize, implement, etc.) by processor circuitry such as a central processing unit executing instructions. Additionally or alternatively, the example alternate model creator circuitry 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

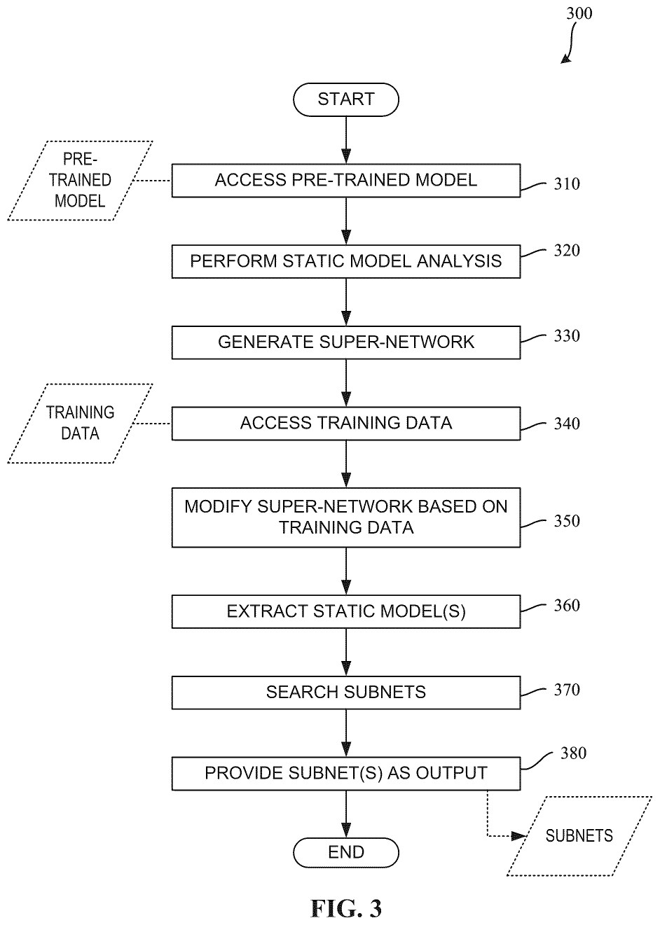

The example alternate model creator circuitry 110 of FIG. 2 includes static model analysis circuitry 210, super-network generation circuitry 220, super-network modification circuitry 230, static model extractor circuitry 240, subnet search circuitry 250, and subnet output circuitry 260. In some examples, the example alternate model creator circuitry 110 is instantiated by processor circuitry executing example alternate model creator instructions and/or configured to perform operations such as those represented by the flowcharts of FIGS. 3, 6, 7, and/or 9.

The example static model analysis circuitry 210 of the illustrated example of FIG. 2 accesses, as an input, a pre-trained static model, and performs a static model analysis. The static model analysis performed by the example model analysis circuitry 210 results in identification of parameter (and/or mappings thereof), loss functions used in the training of the model, hyperparameters used in training of the model, etc. In some examples, the static model analysis results in modification of the model.

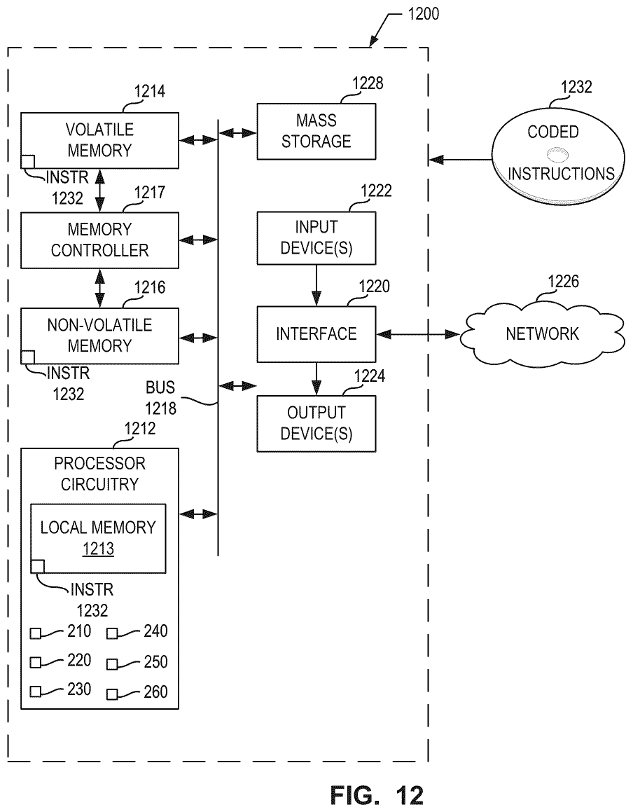

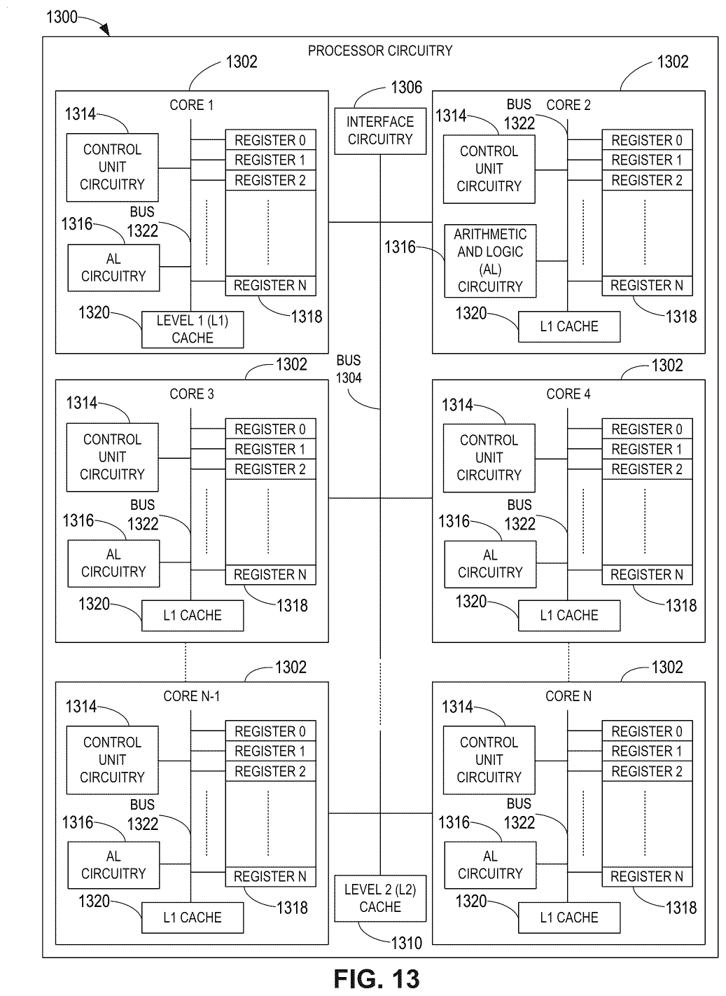

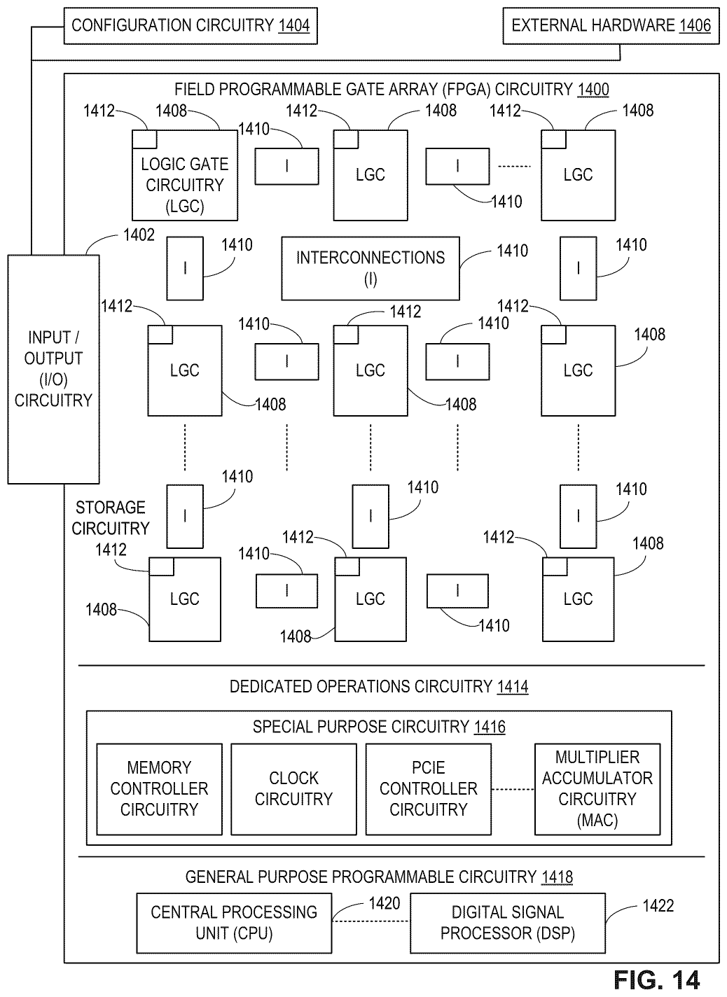

In some examples, the example alternate model creator circuitry 110 includes means for analyzing a static model. For example, the means for analyzing may be implemented by the example static model analysis circuitry 210. In some examples, the static model analysis circuitry 210 may be instantiated by processor circuitry such as the example processor circuitry 1212 of FIG. 12. For instance, the static model analysis circuitry 210 may be instantiated by the example microprocessor 1300 of FIG. 13 executing machine executable instructions such as those implemented by at least blocks 310, 320 of FIG. 3. In some examples, the static model analysis circuitry 210 may be instantiated by hardware logic circuitry, which may be implemented by an ASIC, XPU, or the FPGA circuitry 1400 of FIG. 14 structured to perform operations corresponding to the machine readable instructions. Additionally or alternatively, the static model analysis circuitry 210 may be instantiated by any other combination of hardware, software, and/or firmware. For example, the static model analysis circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example super-network generation circuitry 220 of the illustrated example of FIG. 2, using the analyzed static model, generates a super-network. Such generation includes analysis of which components of the static model can be made elastic. In some examples, the given model might contain components that are not used during inference time. As used herein, a layer of a model or, more generally, a model itself is elastic when the layer (or layers within the model) can have variable values in their properties and/or weighting values. For example, a convolution layer might be considered elastic when it has variable width (e.g., number of channels) or kernel size.

In some examples, the example alternate model creator circuitry 110 includes means for generating a super-network. For example, the means for generating may be implemented by the example super-network generation circuitry 220. In some examples, the example super-network generation circuitry 220 may be instantiated by processor circuitry such as the example processor circuitry 1212 of FIG. 12. For instance, the example super-network generation circuitry 220 may be instantiated by the example microprocessor 1300 of FIG. 13 executing machine executable instructions such as those implemented by at least blocks 330 of FIG. 3. In some examples, the example super-network generation circuitry 220 may be instantiated by hardware logic circuitry, which may be implemented by an ASIC, XPU, or the FPGA circuitry 1400 of FIG. 14 structured to perform operations corresponding to the machine readable instructions. Additionally or alternatively, the example super-network generation circuitry 220 may be instantiated by any other combination of hardware, software, and/or firmware. For example, the example super-network generation circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example super-network modification circuitry 230 of the illustrated example of FIG. 2 accesses training data, and utilizes the training data to modify the super-network. The super-network modification circuitry 230 performs such modification using a training algorithm. In some examples, the training algorithm (and/or other parameters used in training or modifying the super-network) is/are selected by a user. In some examples, to train the network, the super-network modification circuitry 230 performs progressive shrinking of the super-network. To do so, the example super-network modification circuitry 230 fine-tunes the subnetworks within the super-network, shrinking the super-network along various dimensions. In some examples, the shrinking of the super-network is an iterative process, ultimately converging upon a smaller (e.g., shrunk) network. As noted above, three different dimensions may be used for modification of the super-network: elastic kernel, elastic depth, and elastic width.

In some examples, the example alternate model creator circuitry 110 includes means for modifying a super-network. For example, the means for modifying may be implemented by the example super-network modification circuitry 230. In some examples, the example super-network modification circuitry 230 may be instantiated by processor circuitry such as the example processor circuitry 1212 of FIG. 12. For instance, the example super-network modification circuitry 230 may be instantiated by the example microprocessor 1300 of FIG. 13 executing machine executable instructions such as those implemented by at least blocks 340, 350 of FIG. 3. In some examples, the example super-network modification circuitry 230 may be instantiated by hardware logic circuitry, which may be implemented by an ASIC, XPU, or the FPGA circuitry 1400 of FIG. 14 structured to perform operations corresponding to the machine readable instructions. Additionally or alternatively, the example super-network modification circuitry 230 may be instantiated by any other combination of hardware, software, and/or firmware. For example, the example super-network modification circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example static model extractor circuitry 240 of the illustrated example of FIG. 2 extracts static models from the trained super-network. In some examples, the static model extractor circuitry 240 identifies models for extraction based on different combinations of elastic dimensions of the super-network.

In some examples, the example alternate model creator circuitry 110 includes means for extracting a static model. For example, the means for extracting may be implemented by the example static model extractor circuitry 240. In some examples, the example static model extractor circuitry 240 may be instantiated by processor circuitry such as the example processor circuitry 1212 of FIG. 12. For instance, the example static model extractor circuitry 240 may be instantiated by the example microprocessor 1300 of FIG. 13 executing machine executable instructions such as those implemented by at least block 360 of FIG. 3. In some examples, the example static model extractor circuitry 240 may be instantiated by hardware logic circuitry, which may be implemented by an ASIC, XPU, or the FPGA circuitry 1400 of FIG. 14 structured to perform operations corresponding to the machine readable instructions. Additionally or alternatively, the example static model extractor circuitry 240 may be instantiated by any other combination of hardware, software, and/or firmware. For example, the example static model extractor circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example subnet search circuitry 250 of the illustrated example of FIG. 2 searches among the static models to identify a subnetwork that, ideally, outperforms the original model. In general, the subnet search circuitry 250 returns a single subnetwork from the Pareto set that outperforms the original model. However, in some examples, the subnet search circuitry 250 may return any number of sub-networks (e.g., based on accuracy and efficiency requirements).

In some examples, the example alternate model creator circuitry 110 includes means for searching for among extracted subnets. For example, the means for searching may be implemented by the example subnet search circuitry 250. In some examples, the example subnet search circuitry 250 may be instantiated by processor circuitry such as the example processor circuitry 1212 of FIG. 12. For instance, the example subnet search circuitry 250 may be instantiated by the example microprocessor 1300 of FIG. 13 executing machine executable instructions such as those implemented by at least block 370 of FIG. 3. In some examples, the example subnet search circuitry 250 may be instantiated by hardware logic circuitry, which may be implemented by an ASIC, XPU, or the FPGA circuitry 1400 of FIG. 14 structured to perform operations corresponding to the machine readable instructions. Additionally or alternatively, the example subnet search circuitry 250 may be instantiated by any other combination of hardware, software, and/or firmware. For example, the example subnet search circuitry 250 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

The example subnet output circuitry 260 of the illustrated example of FIG. 2 provides the one or more subnets identified by the subnet search circuitry 250 as an output. The example subnet(s) may then be provided for execution by model execution circuitry and/or other structures that may be capable of executing and/or otherwise using a machine learning model. In some examples, the output subnets (and/or data structures representative of such subnets) are provided as files to a user to enable the user to use such subnets in a machine learning environment.

In some examples, the example alternate model creator circuitry 110 includes means for outputting subnetwork(s). For example, the means for outputting may be implemented by the example subnet output circuitry 260. In some examples, the example subnet output circuitry 260 may be instantiated by processor circuitry such as the example processor circuitry 1212 of FIG. 12. For instance, the example subnet output circuitry 260 may be instantiated by the example microprocessor 1300 of FIG. 13 executing machine executable instructions such as those implemented by at least blocks 380 of FIG. 3. In some examples, the example subnet output circuitry 260 may be instantiated by hardware logic circuitry, which may be implemented by an ASIC, XPU, or the FPGA circuitry 1400 of FIG. 14 structured to perform operations corresponding to the machine readable instructions. Additionally or alternatively, the example subnet output circuitry 260 may be instantiated by any other combination of hardware, software, and/or firmware. For example, the example subnet output circuitry 260 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the example alternate model creator circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example static model analysis circuitry 210, the example super-network generation circuitry 220, the example super-network modification circuitry 230, the example static model extractor circuitry 240, the example subnet search circuitry 250, the example subnet output circuitry 260, and/or, more generally, the example alternate model creator circuitry 110 of FIG. 1, may be implemented by hardware alone or by hardware in combination with software and/or firmware. Thus, for example, any of the example static model analysis circuitry 210, the example super-network generation circuitry 220, the example super-network modification circuitry 230, the example static model extractor circuitry 240, the example subnet search circuitry 250, the example subnet output circuitry 260, and/or, more generally, the example alternate model creator circuitry 110, could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example alternate model creator circuitry 110 of FIG. 1 may include one or more elements, processes, and/or devices in addition to, or instead of, those illustrated in FIG. 2, and/or may include more than one of any or all of the illustrated elements, processes and devices.

Flowcharts representative of example machine readable instructions, which may be executed to configure processor circuitry to implement the alternate model creator circuitry 110 of FIG. 2, are shown in FIGS. 3, 6, 7, 9. The machine readable instructions may be one or more executable programs or portion(s) of an executable program for execution by processor circuitry, such as the processor circuitry 1212 shown in the example processor platform 1200 discussed below in connection with FIG. 12 and/or the example processor circuitry discussed below in connection with FIGS. 13 and/or 6. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3, 6, 7, and/or 9, many other methods of implementing the example alternate model creator circuitry 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a compute network or collection of compute networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3, 6, 7, and/or 9 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed and/or instantiated by processor circuitry to generate one or more alternate networks (subnets) based on a pre-trained model. In short, the example alternate model creator circuitry 110 accesses the pre-trained model and automatically creates a super-network based thereon. The alternate model creator circuitry 110 then applies a selected fine-tuning algorithm, and outputs one or more outperforming models (i.e., sub-networks). As noted above, the sub-network is a recognizable derivative of the super-network. To reach a point in which the example alternate model creator circuitry 110 returns efficient subnetworks to the user, the example alternate model creator circuitry 110 performs several stages of operations, as illustrated in FIG. 3. In some examples, the end-user might specify the duration and/or other parameters of such stages. In some examples, such selection(s) may include an identification of algorithms for super-network optimization and subnet search.

The machine readable instructions and/or the operations 300 of FIG. 3 begin at block 310, at which the static model analysis circuitry 210 accesses, as an input, a pre-trained static model. (Block 310). The example model analysis circuitry 210 performs a static model analysis. (Block 320). The static model analysis performed by the example model analysis circuitry 210 results in identification of parameter (and/or mappings thereof), loss functions used in the training of the model, hyperparameters used in training of the model, etc. In some examples, the static model analysis results in modification of the model.

The example super-network generation circuitry 220, using the analyzed static model, generates a super-network. (Block 330.) Such generation includes analysis of which components of the static model can be made elastic. In some examples, the given model might contain components that are not used during inference time. As used herein, a layer of a model or, more generally, a model itself is elastic when the layer (or layers within the model) can have variable values in their properties. For example, a convolution layer might be considered elastic when it has variable width (e.g., number of channels) or kernel size.

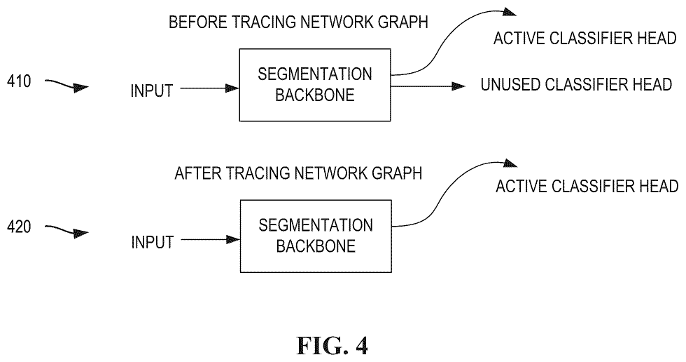

FIG. 4 is a diagram representing a situation in which a portion of a network is not used during inference. In the case of the fully convolutional network for semantic segmentation architecture, two classification heads are defined but only one used. For example, prior to analysis, the model 410 may include an active classifier head and an unused classifier head. After analysis, the unused classifier head may be removed from the model (e.g., model 420). The example super-network generation circuitry 220 determines which classifier is active in the pre-trained model. Upon such identification, the additional classification head can be discarded in the subsequent fine-tuning stages.

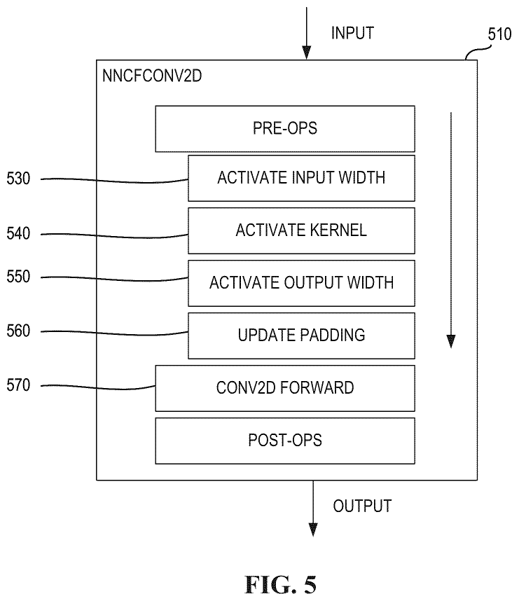

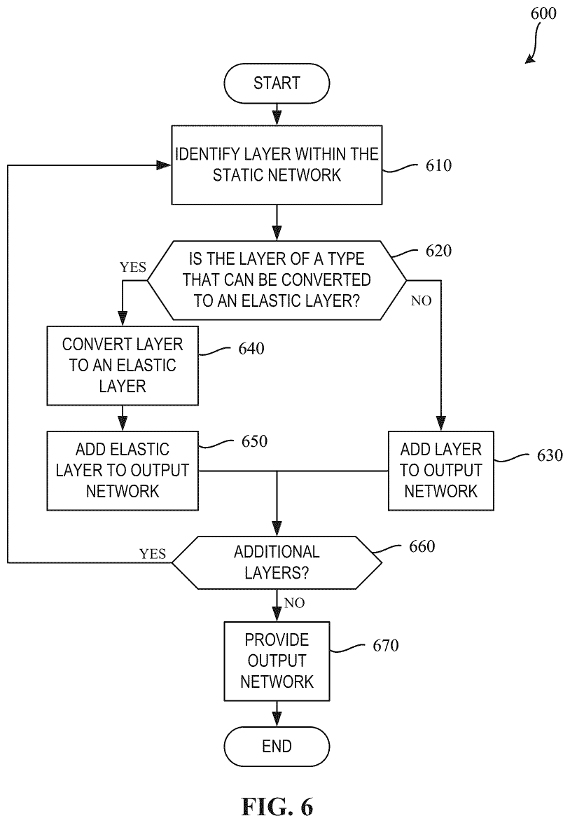

The transformation performed by the super-network generation circuitry 220 results in a super-network that will operate with at least the same accuracy as the original model. In some examples, the transformation of a given network, results in removal of layers (L), for instance, by applying layer fusion. Thus, it might be the case that the super-network contains less layers than the original given model. While the model is traced by the super-network generation circuitry 220, operations that will result in the super-network abstraction are wrapped in accordance with the flowchart of FIG. 6, described below. The example super-network generation circuitry 220, in some examples, changes the model's control flow graph using pre and post hooks, which affect the functionality of the wrapped operations, which are illustrated below in the example of FIG. 5. In this manner, the super-network generation circuitry 220 effectively allows for overriding of a forward function by inserting the additional operator calls before or after the original function.

FIG. 5 is a block diagram illustrating modifications applied to an example machine learning operation. The example diagram of FIG. 5 represents a zoomed in view of the blocks of FIG. 6 that make a layer elastic. In the illustrated example of FIG. 5, an underlying operation (e.g., block 510) is modified by adding several transformations (e.g., blocks 530, 540, 550, 560) before an operator call (e.g., block 570). In the case of convolutions, the layer is adjusted by adding padding and the input (since the previous operator might have an output different from the original). As a result, the operation becomes elastic. Elasticity means that a module/node in a network and its corresponding operator can mutate in several dimensions, allowing for the choice of different kernel sizes (elastic kernel), depths of some group of elements (elastic depth), and number of channels of the selected components (elastic width).

The modification of each static layer is based on its type and a threshold level of elasticity. In some examples, the threshold level of elasticity is determined by the user (e.g., selected by the user, provided by the user, etc.). In some examples, a default threshold level of elasticity is used in association with a framework.

FIG. 6 is a flowchart representative of example machine readable instructions and/or example operations 600 that may be executed and/or instantiated by processor circuitry to convert a static network to an elastic network. The machine readable instructions and/or the operations 600 of FIG. 6 begin when the example super-network generation circuitry 220 selects a layer within a static network for analysis. (Block 610). The example super-network generation circuitry 220 iterates over the layers in the network, deciding whether to make them elastic or not. (Block 620). If the layer is not of a type that can be converted to an elastic layer (e.g., Block 620 returns a result of NO), the example super-network generation circuitry 220 adds the layer to an output network. (Block 630). If the layer is of a type that can be converted to an elastic layer (e.g., Block 620 returns a result of YES), the example super-network generation circuitry 220 applies a transformation to convert the layer to an elastic layer. (Block 640). The elastic layer is then added to the output network by the super-network generation circuitry 220. (Block 650). The super-network generation circuitry 220 determines whether there are additional layers to be considered. (Block 660). If there are additional layers are to be considered (e.g., block 660 returns a result of YES), the process of blocks 610 through 660 is repeated until each layer is processed. If no additional layers are to be considered (e.g., block 660 returns a result of NO), the output network is provided as an output of the super-network generation circuitry 220. (Block 670).

This procedure of FIG. 6 generates the super-network, from which a great number of possible inference paths (subnetworks) can later be selected. Note that the subnetworks share their weights with other subnetworks, and with the super-network. At this stage, weights from the original model become the weights of the super-network. Elastic kernels are implemented by intercepting the weight tensors of the selected modules and applying element-wise calculations to these weight tensors. In some examples, the super-network generation circuitry 220 performs sub-tensor selection and multiplication with an additional tensor of trainable parameters, to remove the spatial dependency of kernel variants on each other inside a given layer. If the resulting tensor of an operation with elastic kernels must have a fixed resolution, then the padding options of such kernel applications are limited to the mode that preserves the output spatial resolution with respect to the input; otherwise, the kernel selection process is not well defined in terms of the output tensor shape. When the transformed model is exported to ONNX, the ultimate kernel selection may be used by directly computing the ONNX node parameters (e.g., selecting the specific sub-tensor and multiplying it by a corresponding transformation matrix to determine the kernel contents) and adding these nodes directly to the ONNX graph currently being exported.

By analogy, elastic width can be introduced by reusing the aforementioned process. In some examples, an implementation of a layer may be overridden by the super-network generation circuitry 220 in such a way that parameters of the layer used in calculations can be intercepted and updated by an arbitrary operation. In some examples, to reduce the width of a layer, the least important output channels of weights can be cut off (e.g., eliminated, filtered, etc.). Such operation can be implemented by the super-network generation circuitry 220 using conventional tensor slicing, provided that the filters are reorganized in descending order of their importance.

In examples disclosed herein, elastic width values are assigned to elastic layers based on dependencies between the layers. For instance, two convolutions are dependent if their outputs are the input of an element-wise operation (e.g., addition, multiplication, or concatenation), so they can't have different number of filters at the same time. Otherwise, the element-wise operation cannot be performed on tensors of different dimensions. In such an example, all such layers are combined into groups by traversing the execution graph. The example super-network generation circuitry 220 uses these groups/clusters to assign the same width values for all layers in the group.

While the example super-network generation circuitry 220 may implement the example process of FIG. 6 to add elastic kernels and elastic width to a super-network, elastic depth requires a different kind of analysis. In some examples, the example super-network generation circuitry 220, to add elastic depth to the super-network, may detect blocks of layers that might be removed from the network to generate shallower subnetworks (e.g., elastic blocks (before optimizing the super-network)), and may skip a subset of these detected blocks without code modification of the model when sampling subnetworks (e.g., during the super-network optimization stage).

In some examples, the example super-network generation circuitry 220 detects blocks that can be skipped based on shapes of inputs and outputs for a candidate block. In some examples, blocks are identified when they satisfy two conditions: (i) the block does not change the shape of feature maps, and (ii) the block has a single input and a single output. If, for example, a block has several branches at the input, but identical tensors run along them, then the example super-network generation circuitry 220 identifies that the block still has a single input. A similar process is implemented by the example super-network generation circuitry 220 with respect to the outputs. Such an approach enables the example super-network generation circuitry 220 to find the building blocks of popular networks (e.g., Bottlenecks for Resnet-50, and Inverted Residual Blocks for MobileNet-v2). However, in some examples, there may be many extra blocks. For example, even consecutive Convolution, BatchNorm, and ReLU operations may produce six blocks: Cony, ReLU, BN, Cony+BN, BN+ReLU, Cony+BN+ReLU. To avoid this, the example super-network generation circuitry 220 combines convolution, batch normalization, and activation layers in the graph into a single node and performs the search for elastic blocks on such a modified graph. In this manner, a large number of nested blocks are eliminated by the fact that a block is not allowed to consist of other blocks.

Selection of the number of layers by the example super-network generation circuitry 220 can be simulated by running the layers to be skipped in a bypass mode. In the bypass mode, a layer directly outputs the inputs without changes. The example super-network generation circuitry 220 overrides the call of any operator (e.g., an operator in PyTorch). In this manner, in some examples, a switch is implemented that enables use of the operator as-is, or in the bypass mode. In this stage, groups are identified by the example super-network generation circuitry 220, and an identifier is assigned to each of the layers in a group. As used herein, a group map represent cells or blocks within the model. In some examples, groups of layers are later used when optimizing the super-network.

Returning to FIG. 3, the super-network modification circuitry 230 accesses training data. (Block 340). The super-network modification circuitry 230 utilizes the training data to modify the super-network. (Block 350). The super-network modification circuitry 230 performs such modification using a training algorithm. In some examples, the training algorithm (and/or other parameters used in training or modifying the super-network) is/are selected by a user.

In some examples, to train the network (Block 350), the super-network modification circuitry 230 performs progressive shrinking of the super-network. To do so, the example super-network modification circuitry 230 fine-tunes the subnetworks within the super-network, shrinking the super-network along various dimensions. As noted above, three different dimensions may be used for modification of the super-network: elastic kernel, elastic depth, and elastic width.

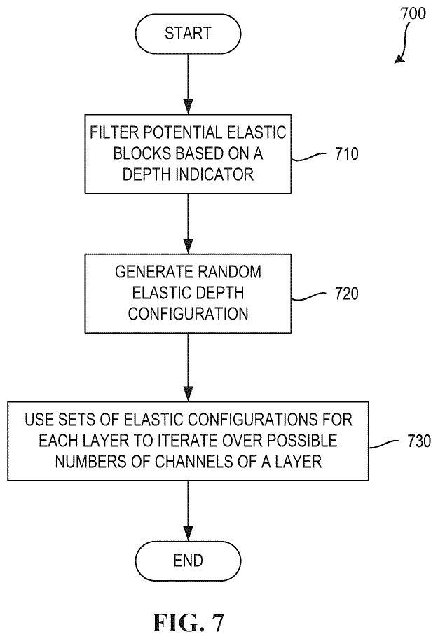

FIG. 7 is a flowchart representative of example machine readable instructions and/or example operations 700 that may be executed and/or instantiated by processor circuitry to perform fine tuning of inner structures of a super-network. The machine readable instructions and/or the operations 700 of FIG. 7 begin when the example super-network modification circuitry 230 filters potential elastic blocks based on a depth indicator that controls the maximum number of elastic blocks that can be removed. (Block 710). After filtering, the super-network modification circuitry 230 generates a randomized elastic depth configuration. (Block 720). When applying progressive shrinking, this configuration may be validated to ensure that the configuration satisfies the shrinking of the network without creating gaps in the elastic depth configuration. The example super-network modification circuitry 230 uses sets of elastic configurations(s) for each layer to iterate over possible numbers of channels of the layer and perform training thereof. (Block 730).

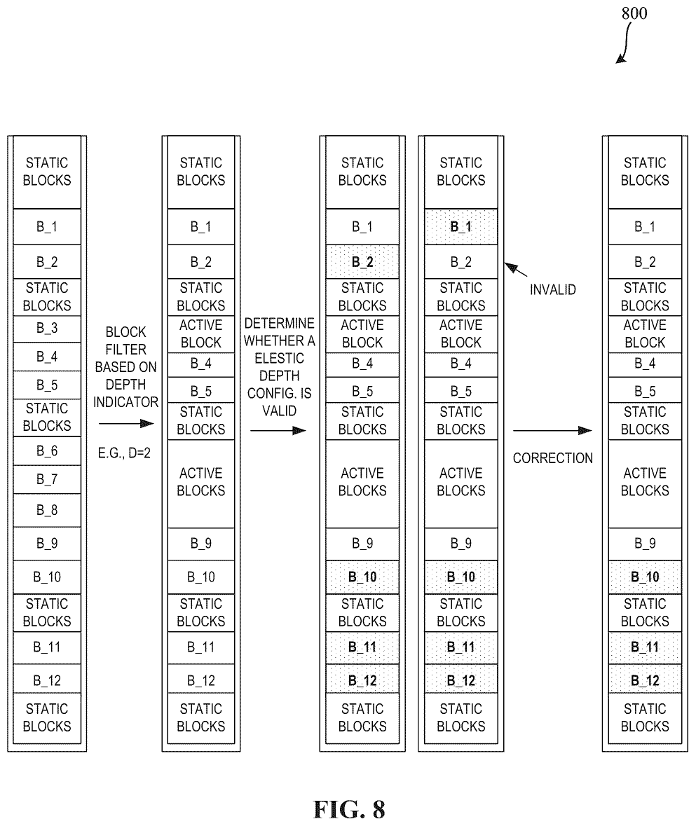

FIG. 8 is a block diagram 800 representing application of elastic depth to an arbitrary super-network following application of progressive shrinking. In the illustrated example of FIG. 8, highlighted blocks (e.g., block 810) will be skipped when sampling a subnetwork. Blocks labeled as static blocks are blocks that are present in each of the subnetworks and therefore are not modified. The remaining blocks are blocks where elastic depth is and/or can be applied.

Returning to FIG. 3, the example static model extractor circuitry 240 extracts static models from the trained super-network. (Block 360). The subnet search circuitry 250 then searches among the static models to identify a subnetwork that, ideally, outperforms the original model. (Block 370). In general, the subnet search circuitry 250 returns a single subnetwork from the Pareto set that outperforms the original model. However, in some examples, the subnet search circuitry 250 may return any number of sub-networks (e.g., based on accuracy and efficiency requirements).

The search stage in super-network-based NAS solutions often require a significant amount of time depending on the size of the search space and the search method strategy. Example approaches disclosed herein sample and evaluate a subset of subnetworks on metrics such as accuracy and latency to be used to train predictors, since search spaces can often involve many possible subnetwork configurations. In some examples, lookup tables are used for predicting latency and aggregate delay by layer/operation to approximate the full delay of the subnetwork model of interest. Once these expensive predictors have been created, the search stage be executed more quickly as compared to collecting performance metrics for each possible sub-network. In some examples, other metrics may be used to approximate performance based on model size, complexity, etc.

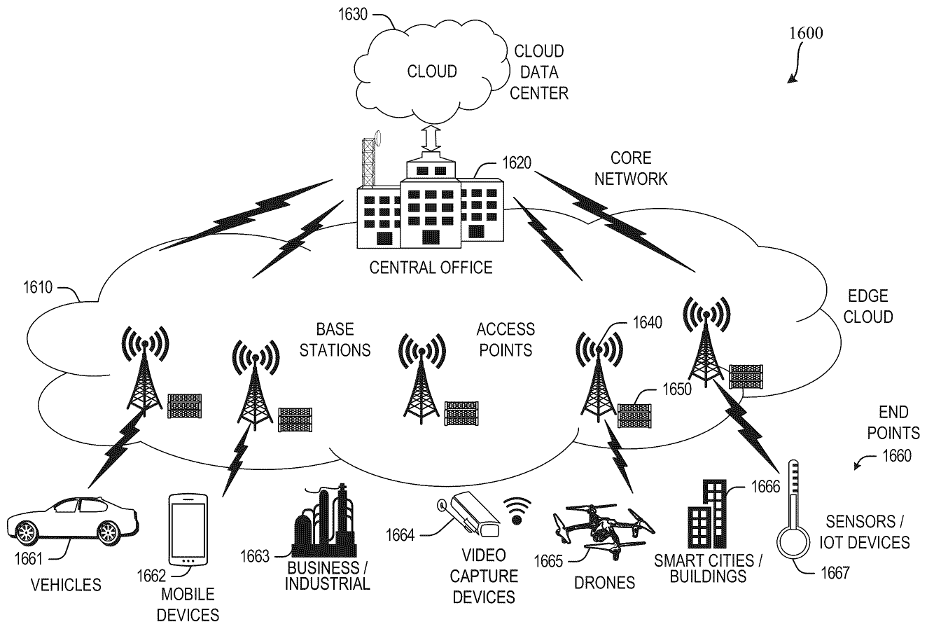

The evaluation of these metrics tends to take less time and offers an alternative to having to train predictors when latency is not an end-user's optimization objective. In examples disclosed herein, a final validation measurement is performed on a few sub-networks (e.g., the best performing candidate sub-networks according to the performance predictions), as predictors may introduce some level of inaccuracy depending on how they were trained. In some examples, to speed up the search procedure, the example subnet search circuitry 250 may implement a random search procedure that uses information from the elastic dimensions as heuristics to quickly identify and/or return good subnetworks. After subnetworks have been searched, the example subnet output circuitry 260 provides the one or more selected subnets as output. (Block 380). The example subnet(s) may then be provided for execution (e.g., deployed) by model execution circuitry and/or other structures that may be capable of executing and/or otherwise using a machine learning model. Such model execution circuitry may be any type of compute device and/or compute network capable of executing a machine learning model (e.g., the selected sub-network). For example, the model execution circuitry may be implemented by an Edge compute device, as described below in connection with FIGS. 16-18. The example process of FIG. 3 then terminates, but may be repeated to, for example, search for additional sub-networks.

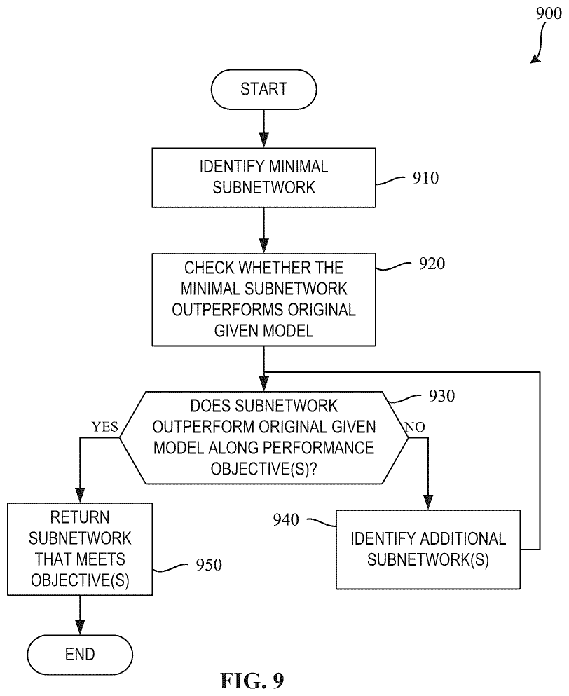

FIG. 9 is a flowchart representative of example machine readable instructions and/or example operations 900 that may be executed and/or instantiated by processor circuitry to identify a subnetwork. In this manner, the flowchart 900 of FIG. 9 may be executed to implement the example block 370 (and, in some examples, block 380) of FIG. 3. The machine readable instructions and/or the operations 900 of FIG. 9 begin when the example subnet search circuitry 250 identifies a minimal subnetwork. (Block 910). In some examples, the subnet search circuitry 250 assumes that the minimal subnetwork (e.g., the subnetwork with the minimum value for each elastic parameter) would require less multiply and accumulate operations (MACs) than the original model. Unfortunately, having less MACs does not always mean that the minimal subnetwork will improve in efficiency, (e.g., latency as compared to the original model). The example subnet search circuitry 250 determines whether the minimal subnetwork outperforms the original model (e.g., along a selected performance metric). (Block 920).

If the minimal subnetwork outperforms the original model (Block 930 returns a result of YES), the example subnet search circuitry 250 returns the subnetwork (e.g., the minimal subnetwork). (Block 950). If the minimal subnetwork does not outperform the original model (Block 930 returns a result of NO), the example subnet search circuitry 250 identifies an additional subnetwork (Block 940), and determines whether the additionally identified subnetwork outperforms the model (Block 930). The process of blocks 930 and 940 is repeated until a subnetwork is identified that outperforms the original model (e.g., until block 930 returns a result of YES, and the identified model is returned, block 950). In some examples, a first identified model may be identified and returned, while a more detailed search is performed. That is, even though a subnetwork is returned by block 950, the search process may continue to search for additional subnetworks that outperform the original model.

FIG. 10 is a graph illustrating performance characteristics of example sub-networks created using example approaches disclosed herein. A vertical axis 1010 represents accuracy of the sub-networks, whereas a horizontal axis 1015 represents a number of multiple and accumulate operations. In the illustrated example of FIG. 10, each dot represents a sub-network. The original model is represented by dot 1020, and additional dots 1030, 1040, 1050 that are selected as a result of execution of the example process disclosed herein are shown. In the illustrated example of FIG. 10, each of the three additionally generated models (corresponding to dots 1030, 1040, 1050) use significantly fewer multiply and accumulate operations (e.g., in the case of the model represented by dot 1040 approximately 50% fewer multiple and accumulate operations), and perform with at least approximately the same amount of accuracy (e.g., within 2% accuracy of the originally trained model). In some examples, the newly identified model may outperform the original model with respect to accuracy. For example, the model represented by dot 1030 represents both an improved accuracy, and fewer multiply and accumulate operations.

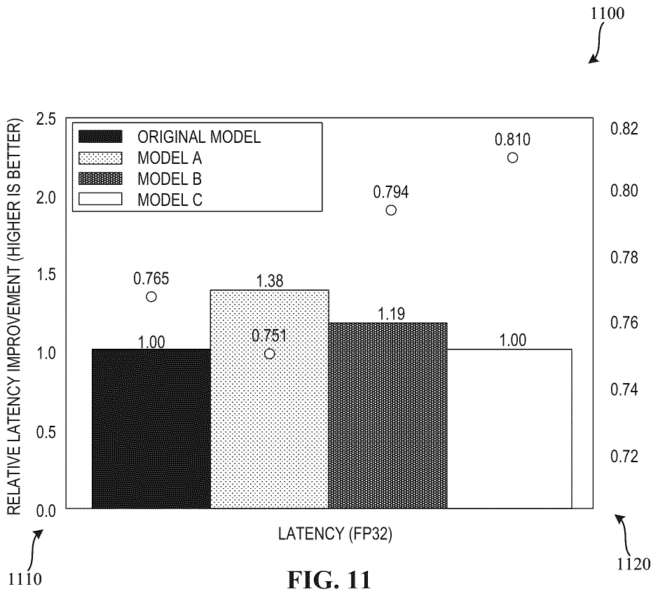

FIG. 11 is a graph illustrating performance improvements of the example models illustrated in FIG. 10. The example graph 1100 includes a left vertical axis 1110 and a right vertical axis 1120. The left vertical axis 1110 (which corresponds to the height of each column represented in the example graph) represents a relative latency improvement of a model as compared with the original model. In the illustrated example of FIG. 11, the relative latency reflects a time-based latency, as compared to a number of operations plotted in FIG. 10. In the illustrated example of FIG. 11, higher relative latency values (e.g., values greater than one) represent improved latency (e.g., a shorter amount of time to execute the model). The right vertical axis 1120 (which corresponds to the vertical placement of the circle corresponding to each column in the example graph) represents the accuracy of the model.

In the illustrated example of FIG. 11, the original model has a relative latency of 1 (e.g., as compared to itself) and an accuracy of 76.5%. Model A has a relative latency of 1.38 (e.g., a 38% improvement in execution latency as compared to the original model), and exhibits an accuracy of 75.1%. A developer may, for example, select model A for use instead of the original model if there was a prioritization of execution latency over accuracy. Model B has a relative latency of 1.19 (e.g., a 19% improvement in execution latency as compared to the original model), and exhibits an accuracy of 79.4%. A developer may, for example, select model B for use instead of the original model if they sought a moderate improvement in both latency and accuracy. Model B has a relative latency of 1.0 (e.g., the same execution latency as the original model), and exhibits an accuracy of 81%. A developer may, for example, select model C if the execution accuracy were to be prioritized. Of note, while model C uses approximately half of the MACs of the original model (as represented in FIG. 10), this reduced number of MACs does not necessarily result in a reduced time-based latency.

FIG. 12 is a block diagram of an example processor platform 1200 structured to execute and/or instantiate the machine readable instructions and/or the operations of FIGS. 3, 6, 7, 9 to implement the alternate model creator circuitry 110 of FIG. 2. The processor platform 1200 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1200 of the illustrated example includes processor circuitry 1212. The processor circuitry 1212 of the illustrated example is hardware. For example, the processor circuitry 1212 can be implemented by one or more integrated circuits, logic circuits, FPGAs, microprocessors, CPUs, GPUs, DSPs, and/or microcontrollers from any desired family or manufacturer. The processor circuitry 1212 may be implemented by one or more semiconductor based (e.g., silicon based) devices. In this example, the processor circuitry 1212 implements the example static model analysis circuitry 210, the example super-network generation circuitry 220, the example super-network modification circuitry 230, the example static model extractor circuitry 240, the example subnet search circuitry 250, and the example subnet output circuitry 260.

The processor circuitry 1212 of the illustrated example includes a local memory 1213 (e.g., a cache, registers, etc.). The processor circuitry 1212 of the illustrated example is in communication with a main memory including a volatile memory 1214 and a non-volatile memory 1216 by a bus 1218. The volatile memory 1214 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1216 may be implemented by flash memory and/or any other desired type of memory device. Access to the main memory 1214, 1216 of the illustrated example is controlled by a memory controller 1217.

The processor platform 1200 of the illustrated example also includes interface circuitry 1220. The interface circuitry 1220 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1222 are connected to the interface circuitry 1220. The input device(s) 1222 permit(s) a user to enter data and/or commands into the processor circuitry 1212. The input device(s) 1222 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1224 are also connected to the interface circuitry 1220 of the illustrated example. The output device(s) 1224 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1220 of the illustrated example, thus, typically includes a graphics driver card, a graphics driver chip, and/or graphics processor circuitry such as a GPU.

The interface circuitry 1220 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1226. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1200 of the illustrated example also includes one or more mass storage devices 1228 to store software and/or data. Examples of such mass storage devices 1228 include magnetic storage devices, optical storage devices, floppy disk drives, HDDs, CDs, Blu-ray disk drives, redundant array of independent disks (RAID) systems, solid state storage devices such as flash memory devices and/or SSDs, and DVD drives.

The machine readable instructions 1232, which may be implemented by the machine readable instructions of FIGS. 3, 6, 7, 9, may be stored in the mass storage device 1228, in the volatile memory 1214, in the non-volatile memory 1216, and/or on a removable non-transitory computer readable storage medium such as a CD or DVD.

FIG. 13 is a block diagram of an example implementation of the processor circuitry 1212 of FIG. 12. In this example, the processor circuitry 1212 of FIG. 12 is implemented by a microprocessor 1300. For example, the microprocessor 1300 may be a general purpose microprocessor (e.g., general purpose microprocessor circuitry). The microprocessor 1300 executes some or all of the machine readable instructions of the flowcharts of FIGS. 3, 6, 7, 9 to effectively instantiate the circuitry of FIG. 2 as logic circuits to perform the operations corresponding to those machine readable instructions. In some such examples, the circuitry of FIG. 2 is instantiated by, the hardware circuits of the microprocessor 1300 in combination with the instructions. For example, the microprocessor 1300 may be implemented by multi-core hardware circuitry such as a CPU, a DSP, a GPU, an XPU, etc. Although it may include any number of example cores 1302 (e.g., 1 core), the microprocessor 1300 of this example is a multi-core semiconductor device including N cores. The cores 1302 of the microprocessor 1300 may operate independently or may cooperate to execute machine readable instructions. For example, machine code corresponding to a firmware program, an embedded software program, or a software program may be executed by one of the cores 1302 or may be executed by multiple ones of the cores 1302 at the same or different times. In some examples, the machine code corresponding to the firmware program, the embedded software program, or the software program is split into threads and executed in parallel by two or more of the cores 1302. The software program may correspond to a portion or all of the machine readable instructions and/or operations represented by the flowcharts of FIGS. 3, 6, 7, 9.

The cores 1302 may communicate by a first example bus 1304. In some examples, the first bus 1304 may be implemented by a communication bus to effectuate communication associated with one(s) of the cores 1302. For example, the first bus 1304 may be implemented by at least one of an Inter-Integrated Circuit (I2C) bus, a Serial Peripheral Interface (SPI) bus, a PCI bus, or a PCIe bus. Additionally or alternatively, the first bus 1304 may be implemented by any other type of computing or electrical bus. The cores 1302 may obtain data, instructions, and/or signals from one or more external devices by example interface circuitry 1306. The cores 1302 may output data, instructions, and/or signals to the one or more external devices by the interface circuitry 1306. Although the cores 1302 of this example include example local memory 1320 (e.g., Level 1 (L1) cache that may be split into an L1 data cache and an L1 instruction cache), the microprocessor 1300 also includes example shared memory 1310 that may be shared by the cores (e.g., Level 2 (L2 cache)) for high-speed access to data and/or instructions. Data and/or instructions may be transferred (e.g., shared) by writing to and/or reading from the shared memory 1310. The local memory 1320 of each of the cores 1302 and the shared memory 1310 may be part of a hierarchy of storage devices including multiple levels of cache memory and the main memory (e.g., the main memory 1214, 1216 of FIG. 12). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1302 may be referred to as a CPU, DSP, GPU, etc., or any other type of hardware circuitry. Each core 1302 includes control unit circuitry 1314, arithmetic and logic (AL) circuitry (sometimes referred to as an ALU) 1316, a plurality of registers 1318, the local memory 1320, and a second example bus 1322. Other structures may be present. For example, each core 1302 may include vector unit circuitry, single instruction multiple data (SIMD) unit circuitry, load/store unit (LSU) circuitry, branch/jump unit circuitry, floating-point unit (FPU) circuitry, etc. The control unit circuitry 1314 includes semiconductor-based circuits structured to control (e.g., coordinate) data movement within the corresponding core 1302. The AL circuitry 1316 includes semiconductor-based circuits structured to perform one or more mathematic and/or logic operations on the data within the corresponding core 1302. The AL circuitry 1316 of some examples performs integer based operations. In other examples, the AL circuitry 1316 also performs floating point operations. In yet other examples, the AL circuitry 1316 may include first AL circuitry that performs integer based operations and second AL circuitry that performs floating point operations. In some examples, the AL circuitry 1316 may be referred to as an Arithmetic Logic Unit (ALU). The registers 1318 are semiconductor-based structures to store data and/or instructions such as results of one or more of the operations performed by the AL circuitry 1316 of the corresponding core 1302. For example, the registers 1318 may include vector register(s), SIMD register(s), general purpose register(s), flag register(s), segment register(s), machine specific register(s), instruction pointer register(s), control register(s), debug register(s), memory management register(s), machine check register(s), etc. The registers 1318 may be arranged in a bank as shown in FIG. 13. Alternatively, the registers 1318 may be organized in any other arrangement, format, or structure including distributed throughout the core 1302 to shorten access time. The second bus 1322 may be implemented by at least one of an I2C bus, a SPI bus, a PCI bus, or a PCIe bus

Each core 1302 and/or, more generally, the microprocessor 1300 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1300 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 14 is a block diagram of another example implementation of the processor circuitry 1212 of FIG. 12. In this example, the processor circuitry 1212 is implemented by FPGA circuitry 1400. For example, the FPGA circuitry 1400 may be implemented by an FPGA. The FPGA circuitry 1400 can be used, for example, to perform operations that could otherwise be performed by the example microprocessor 1300 of FIG. 13 executing corresponding machine readable instructions. However, once configured, the FPGA circuitry 1400 instantiates the machine readable instructions in hardware and, thus, can often execute the operations faster than they could be performed by a general purpose microprocessor executing the corresponding software.

More specifically, in contrast to the microprocessor 1300 of FIG. 13 described above (which is a general purpose device that may be programmed to execute some or all of the machine readable instructions represented by the flowchart of FIG. but whose interconnections and logic circuitry are fixed once fabricated), the FPGA circuitry 1400 of the example of FIG. 6 includes interconnections and logic circuitry that may be configured and/or interconnected in different ways after fabrication to instantiate, for example, some or all of the machine readable instructions represented by the flowchart of FIG. ______. In particular, the FPGA circuitry 1400 may be thought of as an array of logic gates, interconnections, and switches. The switches can be programmed to change how the logic gates are interconnected by the interconnections, effectively forming one or more dedicated logic circuits (unless and until the FPGA circuitry 1400 is reprogrammed). The configured logic circuits enable the logic gates to cooperate in different ways to perform different operations on data received by input circuitry. Those operations may correspond to some or all of the software represented by the flowchart of FIG. ______. As such, the FPGA circuitry 1400 may be structured to effectively instantiate some or all of the machine readable instructions of the flowchart of FIG. as dedicated logic circuits to perform the operations corresponding to those software instructions in a dedicated manner analogous to an ASIC. Therefore, the FPGA circuitry 1400 may perform the operations corresponding to the some or all of the machine readable instructions of FIG. faster than the general purpose microprocessor can execute the same.

In the example of FIG. 6, the FPGA circuitry 1400 is structured to be programmed (and/or reprogrammed one or more times) by an end user by a hardware description language (HDL) such as Verilog. The FPGA circuitry 1400 of FIG. 6, includes example input/output (I/O) circuitry 1402 to obtain and/or output data to/from example configuration circuitry 1404 and/or external hardware 1406. For example, the configuration circuitry 1404 may be implemented by interface circuitry that may obtain machine readable instructions to configure the FPGA circuitry 1400, or portion(s) thereof. In some such examples, the configuration circuitry 1404 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1406 may be implemented by external hardware circuitry. For example, the external hardware 1406 may be implemented by the microprocessor 1300 of FIG. 13. The FPGA circuitry 1400 also includes an array of example logic gate circuitry 1408, a plurality of example configurable interconnections 1410, and example storage circuitry 1412. The logic gate circuitry 1408 and the configurable interconnections 1410 are configurable to instantiate one or more operations that may correspond to at least some of the machine readable instructions of FIG. and/or other desired operations. The logic gate circuitry 1408 shown in FIG. 6 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1408 to enable configuration of the electrical structures and/or the logic gates to form circuits to perform desired operations. The logic gate circuitry 1408 may include other electrical structures such as look-up tables (LUTs), registers (e.g., flip-flops or latches), multiplexers, etc.

The configurable interconnections 1410 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1408 to program desired logic circuits.

The storage circuitry 1412 of the illustrated example is structured to store result(s) of the one or more of the operations performed by corresponding logic gates. The storage circuitry 1412 may be implemented by registers or the like. In the illustrated example, the storage circuitry 1412 is distributed amongst the logic gate circuitry 1408 to facilitate access and increase execution speed.

The example FPGA circuitry 1400 of FIG. 6 also includes example Dedicated Operations Circuitry 1414. In this example, the Dedicated Operations Circuitry 1414 includes special purpose circuitry 1416 that may be invoked to implement commonly used functions to avoid the need to program those functions in the field. Examples of such special purpose circuitry 1416 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1400 may also include example general purpose programmable circuitry 1418 such as an example CPU 1420 and/or an example DSP 1422. Other general purpose programmable circuitry 1418 may additionally or alternatively be present such as a GPU, an XPU, etc., that can be programmed to perform other operations.

Although FIGS. 13 and 6 illustrate two example implementations of the processor circuitry 1212 of FIG. 12, many other approaches are contemplated. For example, as mentioned above, modern FPGA circuitry may include an on-board CPU, such as one or more of the example CPU 1420 of FIG. 14. Therefore, the processor circuitry 1212 of FIG. 12 may additionally be implemented by combining the example microprocessor 1300 of FIG. 13 and the example FPGA circuitry 1400 of FIG. 6. In some such hybrid examples, a first portion of the machine readable instructions represented by the flowcharts of FIGS. 3, 6, 7, and/or 9 may be executed by one or more of the cores 1302 of FIG. 13, a second portion of the machine readable instructions represented by the flowcharts of FIGS. 3, 6, 7, and/or 9 may be executed by the FPGA circuitry 1400 of FIG. 6, and/or a third portion of the machine readable instructions represented by the flowcharts of FIGS. 3, 6, 7, and/or 9 may be executed by an ASIC. It should be understood that some or all of the circuitry of FIG. 2 may, thus, be instantiated at the same or different times. Some or all of the circuitry may be instantiated, for example, in one or more threads executing concurrently and/or in series. Moreover, in some examples, some or all of the circuitry of FIG. 2 may be implemented within one or more virtual machines and/or containers executing on the microprocessor.

In some examples, the processor circuitry 1212 of FIG. 12 may be in one or more packages. For example, the microprocessor 1300 of FIG. 13 and/or the FPGA circuitry 1400 of FIG. 6 may be in one or more packages. In some examples, an XPU may be implemented by the processor circuitry 1212 of FIG. 12, which may be in one or more packages. For example, the XPU may include a CPU in one package, a DSP in another package, a GPU in yet another package, and an FPGA in still yet another package.

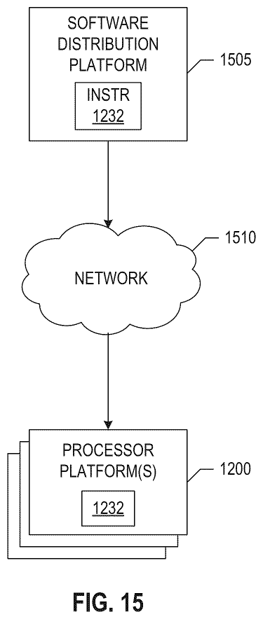

A block diagram illustrating an example software distribution platform 1505 to distribute software such as the example machine readable instructions 1232 of FIG. 12 to hardware devices owned and/or operated by third parties is illustrated in FIG. 15. The example software distribution platform 1505 may be implemented by any computer server, data facility, cloud service, etc., capable of storing and transmitting software to other computing devices. The third parties may be customers of the entity owning and/or operating the software distribution platform 1505. For example, the entity that owns and/or operates the software distribution platform 1505 may be a developer, a seller, and/or a licensor of software such as the example machine readable instructions 1232 of FIG. 12. The third parties may be consumers, users, retailers, OEMs, etc., who purchase and/or license the software for use and/or re-sale and/or sub-licensing. In the illustrated example, the software distribution platform 1505 includes one or more servers and one or more storage devices. The storage devices store the machine readable instructions 1232, which may correspond to the example machine readable instructions of FIGS. 3, 6, 7, and/or 9, as described above. The one or more servers of the example software distribution platform 1505 are in communication with an example network 1510, which may correspond to any one or more of the Internet and/or any of the example networks 1226 described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1232 from the software distribution platform 1505. For example, the software, which may correspond to the example machine readable instructions FIGS. 3, 6, 7, and/or 9, may be downloaded to the example processor platform 1200, which is to execute the machine readable instructions 1232 to implement the alternate model creator circuitry 110. In some examples, one or more servers of the software distribution platform 1505 periodically offer, transmit, and/or force updates to the software (e.g., the example machine readable instructions 1232 of FIG. 12) to ensure improvements, patches, updates, etc., are distributed and applied to the software at the end user devices.

FIG. 16 is a block diagram 1600 showing an overview of a configuration for Edge computing, which includes a layer of processing referred to in many of the following examples as an “Edge cloud”. As shown, the Edge cloud 1610 is co-located at an Edge location, such as an access point or base station 1640, a local processing hub 1650, or a central office 1620, and thus may include multiple entities, devices, and equipment instances. The Edge cloud 1610 is located much closer to the endpoint (consumer and producer) data sources 1660 (e.g., autonomous vehicles 1661, user equipment 1662, business and industrial equipment 1663, video capture devices 1664, drones 1665, smart cities and building devices 1666, sensors and IoT devices 1667, etc.) than the cloud data center 1630. Compute, memory, and storage resources which are offered at the edges in the Edge cloud 1610 are critical to providing ultra-low latency response times for services and functions used by the endpoint data sources 1660 as well as reduce network backhaul traffic from the Edge cloud 1610 toward cloud data center 1630 thus improving energy consumption and overall network usages among other benefits.

In some examples, the alternate model creator circuitry 110 may be implemented at the cloud data center 1640, the central office 1620, or even in some examples, at an edge device 1660, and may create/select a sub-network for execution at an edge device 1660. In some examples, an edge device 1660 may generate a sub-network for execution at another Edge device within the Edge network (e.g., within the Edge could 1610, at the central office 1620, at a cloud data center 1630, etc.).

Compute, memory, and storage are scarce resources, and generally decrease depending on the Edge location (e.g., fewer processing resources being available at consumer endpoint devices, than at a base station, than at a central office). However, the closer that the Edge location is to the endpoint (e.g., user equipment (UE)), the more that space and power is often constrained. Thus, Edge computing attempts to reduce the amount of resources needed for network services, through the distribution of more resources which are located closer both geographically and in network access time. In this manner, Edge computing attempts to bring the compute resources to the workload data where appropriate, or, bring the workload data to the compute resources.

The following describes aspects of an Edge cloud architecture that covers multiple potential deployments and addresses restrictions that some network operators or service providers may have in their own infrastructures. These include, variation of configurations based on the Edge location (because edges at a base station level, for instance, may have more constrained performance and capabilities in a multi-tenant scenario); configurations based on the type of compute, memory, storage, fabric, acceleration, or like resources available to Edge locations, tiers of locations, or groups of locations; the service, security, and management and orchestration capabilities; and related objectives to achieve usability and performance of end services. These deployments may accomplish processing in network layers that may be considered as “near Edge”, “close Edge”, “local Edge”, “middle Edge”, or “far Edge” layers, depending on latency, distance, and timing characteristics.

Edge computing is a developing paradigm where computing is performed at or closer to the “Edge” of a network, typically through the use of a compute platform (e.g., x86 or ARM compute hardware architecture) implemented at base stations, gateways, network routers, or other devices which are much closer to endpoint devices producing and consuming the data. For example, Edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within Edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

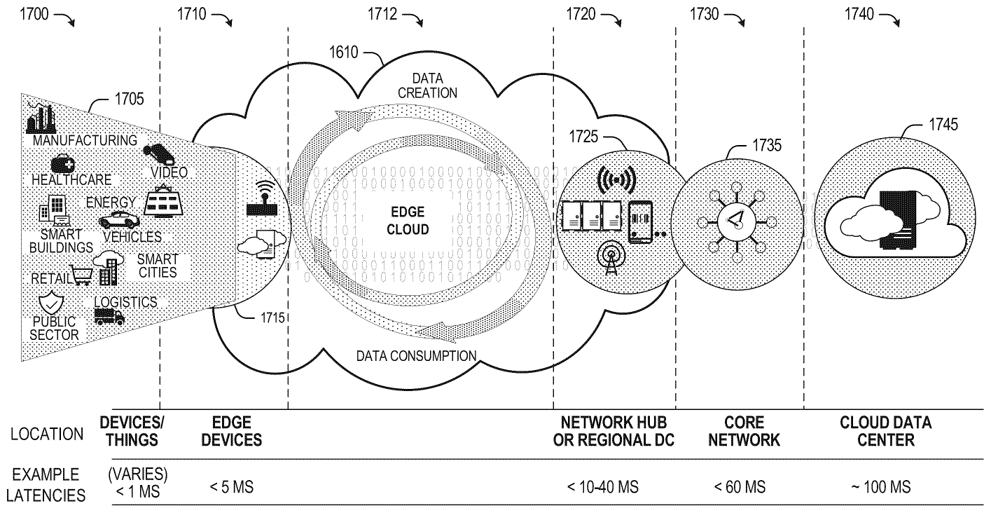

FIG. 17 illustrates operational layers among endpoints, an Edge cloud, and cloud computing environments. Specifically, FIG. 17 depicts examples of computational use cases 1705, utilizing the Edge cloud 1610 among multiple illustrative layers of network computing. The layers begin at an endpoint (devices and things) layer 1700, which accesses the Edge cloud 1610 to conduct data creation, analysis, and data consumption activities. The Edge cloud 1610 may span multiple network layers, such as an Edge devices layer 1710 having gateways, on-premise servers, or network equipment (nodes 1715) located in physically proximate Edge systems; a network access layer 1720, encompassing base stations, radio processing units, network hubs, regional data centers (DC), or local network equipment (equipment 1725); and any equipment, devices, or nodes located therebetween (in layer 1712, not illustrated in detail). The network communications within the Edge cloud 1610 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 1700, under 5 ms at the Edge devices layer 1710, to even between 10 to 40 ms when communicating with nodes at the network access layer 1720. Beyond the Edge cloud 1610 are core network 1730 and cloud data center 1740 layers, each with increasing latency (e.g., between 50-60 ms at the core network layer 1730, to 100 or more ms at the cloud data center layer). As a result, operations at a core network data center 1735 or a cloud data center 1745, with latencies of at least 50 to 100 ms or more, will not be able to accomplish many time-critical functions of the use cases 1705. Each of these latency values are provided for purposes of illustration and contrast; it will be understood that the use of other access network mediums and technologies may further reduce the latencies. In some examples, respective portions of the network may be categorized as “close Edge”, “local Edge”, “near Edge”, “middle Edge”, or “far Edge” layers, relative to a network source and destination. For instance, from the perspective of the core network data center 1735 or a cloud data center 1745, a central office or content data network may be considered as being located within a “near Edge” layer (“near” to the cloud, having high latency values when communicating with the devices and endpoints of the use cases 1705), whereas an access point, base station, on-premise server, or network gateway may be considered as located within a “far Edge” layer (“far” from the cloud, having low latency values when communicating with the devices and endpoints of the use cases 1705). It will be understood that other categorizations of a particular network layer as constituting a “close”, “local”, “near”, “middle”, or “far” Edge may be based on latency, distance, number of network hops, or other measurable characteristics, as measured from a source in any of the network layers 1700-1740.

The various use cases 1705 may access resources under usage pressure from incoming streams, due to multiple services utilizing the Edge cloud. To achieve results with low latency, the services executed within the Edge cloud 1610 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor, etc.).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to Service Level Agreement (SLA), the system as a whole (components in the transaction) may provide the ability to (1) understand the impact of the SLA violation, and (2) augment other components in the system to resume overall transaction SLA, and (3) implement steps to remediate.

Thus, with these variations and service features in mind, Edge computing within the Edge cloud 1610 may provide the ability to serve and respond to multiple applications of the use cases 1705 (e.g., object tracking, video surveillance, connected cars, etc.) in real-time or near real-time, and meet ultra-low latency requirements for these multiple applications. These advantages enable a whole new class of applications (e.g., Virtual Network Functions (VNFs), Function as a Service (FaaS), Edge as a Service (EaaS), standard processes, etc.), which cannot leverage conventional cloud computing due to latency or other limitations.

However, with the advantages of Edge computing comes the following caveats. The devices located at the Edge are often resource constrained and therefore there is pressure on usage of Edge resources. Typically, this is addressed through the pooling of memory and storage resources for use by multiple users (tenants) and devices. The Edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because Edge locations may be unmanned and may even need permissioned access (e.g., when housed in a third-party location). Such issues are magnified in the Edge cloud 1610 in a multi-tenant, multi-owner, or multi-access setting, where services and applications are requested by many users, especially as network usage dynamically fluctuates and the composition of the multiple stakeholders, use cases, and services changes.

At a more generic level, an Edge computing system may be described to encompass any number of deployments at the previously discussed layers operating in the Edge cloud 1610 (network layers 1700-1740), which provide coordination from client and distributed computing devices. One or more Edge gateway nodes, one or more Edge aggregation nodes, and one or more core data centers may be distributed across layers of the network to provide an implementation of the Edge computing system by or on behalf of a telecommunication service provider (“telco”, or “TSP”), internet-of-things service provider, cloud service provider (CSP), enterprise entity, or any other number of entities. Various implementations and configurations of the Edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the Edge computing system does not necessarily mean that such node or device operates in a client or agent/minion/follower role; rather, any of the nodes or devices in the Edge computing system refer to individual entities, nodes, or subsystems which include discrete or connected hardware or software configurations to facilitate or use the Edge cloud 1610.

As such, the Edge cloud 1610 is formed from network components and functional features operated by and within Edge gateway nodes, Edge aggregation nodes, or other Edge compute nodes among network layers 1710-1730. The Edge cloud 1610 thus may be embodied as any type of network that provides Edge computing and/or storage resources which are proximately located to radio access network (RAN) capable endpoint devices (e.g., mobile computing devices, IoT devices, smart devices, etc.), which are discussed herein. In other words, the Edge cloud 1610 may be envisioned as an “Edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks, etc.) may also be utilized in place of or in combination with such 3GPP carrier networks.

The network components of the Edge cloud 1610 may be servers, multi-tenant servers, appliance computing devices, and/or any other type of computing devices. For example, the Edge cloud 1610 may include an appliance computing device that is a self-contained electronic device including a housing, a chassis, a case, or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., electromagnetic interference (EMI), vibration, extreme temperatures, etc.), and/or enable submergibility. Example housings may include power circuitry to provide power for stationary and/or portable implementations, such as alternating current (AC) power inputs, direct current (DC) power inputs, AC/DC converter(s), DC/AC converter(s), DC/DC converter(s), power regulators, transformers, charging circuitry, batteries, wired inputs, and/or wireless power inputs. Example housings and/or surfaces thereof may include or connect to mounting hardware to enable attachment to structures such as buildings, telecommunication structures (e.g., poles, antenna structures, etc.), and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, infrared or other visual thermal sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, rotors such as propellers, etc.) and/or articulating hardware (e.g., robot arms, pivotable appendages, etc.). In some circumstances, the sensors may include any type of input devices such as user interface hardware (e.g., buttons, switches, dials, sliders, microphones, etc.). In some circumstances, example housings include output devices contained in, carried by, embedded therein and/or attached thereto. Output devices may include displays, touchscreens, lights, light-emitting diodes (LEDs), speakers, input/output (I/O) ports (e.g., universal serial bus (USB)), etc. In some circumstances, Edge devices are devices presented in the network for a specific purpose (e.g., a traffic light), but may have processing and/or other capacities that may be utilized for other purposes. Such Edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. D1B. The Edge cloud 1610 may also include one or more servers and/or one or more multi-tenant servers. Such a server may include an operating system and implement a virtual computing environment. A virtual computing environment may include a hypervisor managing (e.g., spawning, deploying, commissioning, destroying, decommissioning, etc.) one or more virtual machines, one or more containers, etc. Such virtual computing environments provide an execution environment in which one or more applications and/or other software, code, or scripts may execute while being isolated from one or more other applications, software, code, or scripts.

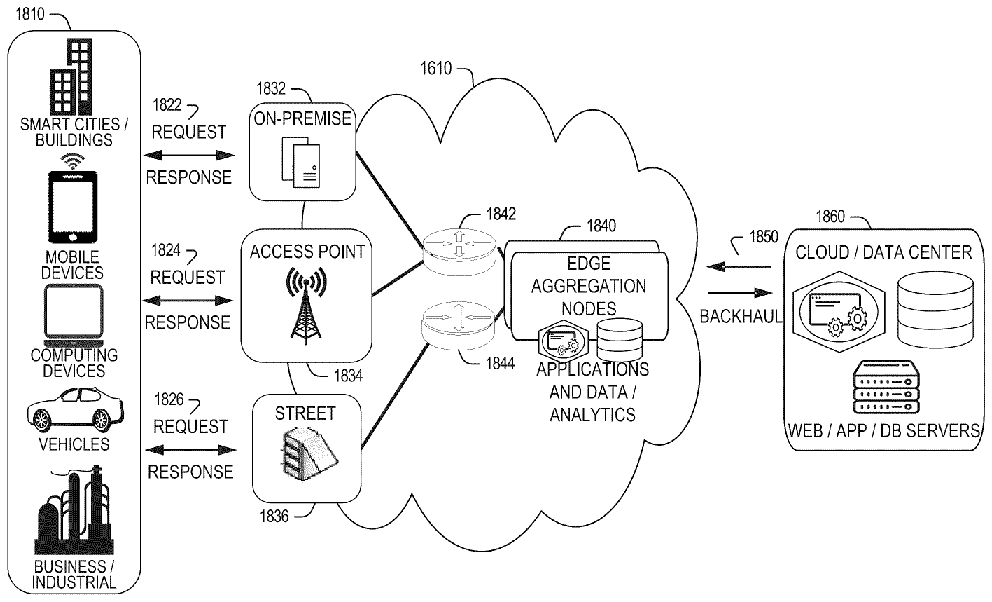

In FIG. 18, various client endpoints 1810 (in the form of mobile devices, computers, autonomous vehicles, business computing equipment, industrial processing equipment) exchange requests and responses that are specific to the type of endpoint network aggregation. For instance, client endpoints 1810 may obtain network access via a wired broadband network, by exchanging requests and responses 1822 through an on-premise network system 1832. Some client endpoints 1810, such as mobile computing devices, may obtain network access via a wireless broadband network, by exchanging requests and responses 1824 through an access point (e.g., a cellular network tower) 1834. Some client endpoints 1810, such as autonomous vehicles may obtain network access for requests and responses 1826 via a wireless vehicular network through a street-located network system 1836. However, regardless of the type of network access, the TSP may deploy aggregation points 1842, 1844 within the Edge cloud 1610 to aggregate traffic and requests. Thus, within the Edge cloud 1610, the TSP may deploy various compute and storage resources, such as at Edge aggregation nodes 1840, to provide requested content. The Edge aggregation nodes 1840 and other systems of the Edge cloud 1610 are connected to a cloud or data center 1860, which uses a backhaul network 1850 to fulfill higher-latency requests from a cloud/data center for websites, applications, database servers, etc. Additional or consolidated instances of the Edge aggregation nodes 1840 and the aggregation points 1842, 1844, including those deployed on a single server framework, may also be present within the Edge cloud 1610 or other areas of the TSP infrastructure.

From the foregoing, it will be appreciated that example systems, methods, apparatus, and articles of manufacture have been disclosed that enable generation of new machine learning models based on pre-trained models using neural architecture search. Disclosed systems, methods, apparatus, and articles of manufacture improve the efficiency of using a computing device by enabling automated design of the NAS search space by bootstrapping a pre-trained model. Such approaches introduce efficient methods for network transformation to convert a static architecture into a super-network, for subsequent generation of new alternate network(s)/model(s). Because such new alternate network(s)/model(s) can perform with higher accuracy and/or be more performant (e.g., lower latency, lower compute resources required, etc.), use of such new alternate network(s)/models(s) enable more efficient use of compute systems. Disclosed systems, methods, apparatus, and articles of manufacture are accordingly directed to one or more improvement(s) in the operation of a machine such as a computer or other electronic and/or mechanical device.

It is noted that this patent claims priority from provisional Patent Application No. 63/262,245, which was filed on Oct. 7, 2021, and U.S. Provisional Patent Application No. 63/208,945, which was filed on Jun. 9, 2021, which are hereby incorporated by reference in their entireties.

Example methods, apparatus, systems, and articles of manufacture to modify pre-trained models to apply neural architecture search are disclosed herein. Further examples and combinations thereof include the following:
Example 1 includes an apparatus to modify pre-trained machine learning models, the apparatus comprising at least one memory, machine readable instructions, and processor circuitry to at least one of instantiate or execute the machine readable instructions to access a pre-trained machine learning model, create a super-network based on the pre-trained machine learning model, create a plurality of subnetworks based on the super-network, and search the plurality of subnetworks to select a subnetwork.
Example 2 includes the apparatus of example 1, wherein to create the super-network, the processor circuitry is to determine whether a layer of the pre-trained machine learning model is of a type that can be converted to an elastic layer, and responsive to the determination that the layer is of a type that can be converted to the elastic layer, convert the layer to the elastic layer and add the elastic layer to the super-network.
Example 3 includes the apparatus of example 2, wherein the elastic layer includes at least one variable property.
Example 4 includes the apparatus of example 3, wherein the variable property is a variable depth of the elastic layer.
Example 5 includes the apparatus of example 3, wherein the variable property is a variable width of the elastic layer.
Example 6 includes the apparatus of example 1, wherein the processor circuitry is to, prior to extraction of the plurality of subnetworks, modify the super-network based on training data.
Example 7 includes the apparatus of example 6, wherein the modification of the super-network is performed using a training algorithm.
Example 8 includes the apparatus of example 7, wherein the training algorithm is Progressive Shrinking.
Example 9 includes the apparatus of example 1, wherein the selection of the sub-network is based on at least one of a performance characteristic of the sub-network.
Example 10 includes the apparatus of example 9, wherein the performance characteristic of the sub-network is an estimated performance characteristic.
Example 11 includes the apparatus of example 9, wherein the selection of the sub-network is based on the performance characteristic meeting or exceeding a corresponding performance characteristic of the pre-trained machine learning model.
Example 12 includes the apparatus of example 11, wherein the performance characteristic is accuracy.
Example 13 includes the apparatus of example 1, wherein the processor is to distribute the selected sub-network to a compute device for execution.
Example 14 includes the apparatus of example 13, wherein the compute device is an Edge device within an Edge computing environment.
Example 15 includes the apparatus of example 13, wherein the processor is to select the sub-network such that an operational characteristic of the sub-network meets an operational requirement of the compute device.
Example 16 includes the apparatus of example 15, wherein the operational characteristic of the sub-network is a size of the sub-network and the operational requirement of the compute device is an amount of available memory of the compute device.
Example 16 includes a machine readable storage medium comprising instructions that, when executed, cause processor circuitry to at least access a pre-trained machine learning model, create a super-network based on the pre-trained machine learning model, create a plurality of subnetworks based on the super-network, and search the plurality of subnetworks to select a subnetwork.
Example 17 includes the machine readable storage medium of example 16, wherein the instructions to create the super-network, cause the processor circuitry to at least determine whether a layer of the pre-trained machine learning model is of a type that can be converted to an elastic layer, and responsive to the determination that the layer is of a type that can be converted to the elastic layer, convert the layer to the elastic layer and add the elastic layer to the super-network.
Example 18 includes the machine readable storage medium of example 17, wherein the elastic layer includes at least one variable property.
Example 19 includes the machine readable storage medium of example 18, wherein the variable property is a variable number of channels of the elastic layer.
Example 20 includes the machine readable storage medium of example 18, wherein the variable property is a variable width of the elastic layer.
Example 21 includes the machine readable storage medium of example 16, wherein the instructions, when executed, cause the processor circuitry to, prior to extraction of the plurality of subnetworks, modify the super-network based on training data.
Example 22 includes the machine readable storage medium of example 21, wherein the instructions, when executed, cause the processor circuitry to modify the super-network using a training algorithm.
Example 23 includes the machine readable storage medium of example 22, wherein the training algorithm is Progressive shrinking.
Example 24 includes a method to modify pre-trained models and apply neural architecture search, the method comprising accessing a pre-trained machine learning model, creating, by executing an instruction with at least one processor, a super-network based on the pre-trained machine learning model, extracting, by executing an instruction with the at least one processor, a plurality of subnetworks from the super-network, and searching the plurality of subnetworks to select a subnetwork.
Example 25 includes the method of example 24, wherein the creating of the super-network includes determining whether a layer of the pre-trained machine learning model is of a type that can be converted to an elastic layer, and responsive to the determination that the layer is of a type that can be converted to the elastic layer, converting the layer to the elastic layer and add the elastic layer to the super-network.
Example 26 includes the method of example 25, wherein the elastic layer includes at least one variable property.
Example 27 includes the method of example 26, wherein the variable property is a variable depth of the elastic layer.
Example 28 includes the method of example 26, wherein the variable property is a variable width of the elastic layer.
Example 29 includes the method of example 24, further including, prior to extraction of the plurality of subnetworks, modifying the super-network based on training data.
Example 30 includes the method of example 29, further including modifying the super-network using a training algorithm.
Example 31 includes an apparatus to modify pre-trained models the apparatus comprising means for accessing a pre-trained machine learning model, means for creating a super-network based on the pre-trained machine learning model, means for extracting a plurality of subnetworks from the super-network, and means for searching the plurality of subnetworks to select a subnetwork.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus to modify pre-trained machine learning models, the apparatus comprising:
at least one memory;
machine readable instructions; and
processor circuitry to at least one of instantiate or execute the machine readable instructions to:
access a pre-trained machine learning model;
create a super-network based on the pre-trained machine learning model;
create a plurality of subnetworks based on the super-network; and
search the plurality of subnetworks to select a subnetwork.

2. The apparatus of claim 1, wherein to create the super-network, the processor circuitry is to:
determine whether a layer of the pre-trained machine learning model is of a type that can be converted to an elastic layer; and
responsive to the determination that the layer is of a type that can be converted to the elastic layer, convert the layer to the elastic layer and add the elastic layer to the super-network.

3. The apparatus of claim 2, wherein the elastic layer includes at least one variable property.

4. The apparatus of claim 3, wherein the variable property is a variable depth of the elastic layer.

5. The apparatus of claim 3, wherein the variable property is a variable width of the elastic layer.

6. The apparatus of claim 1, wherein the processor circuitry is to, prior to extraction of the plurality of subnetworks, modify the super-network based on training data.

7. The apparatus of claim 6, wherein the modification of the super-network is performed using a training algorithm.

8. The apparatus of claim 7, wherein the training algorithm is Progressive Shrinking.

9. The apparatus of claim 1, wherein the selection of the sub-network is based on at least one of a performance characteristic of the sub-network.

10. The apparatus of claim 9, wherein the performance characteristic of the sub-network is an estimated performance characteristic.

11. The apparatus of claim 9, wherein the selection of the sub-network is based on the performance characteristic meeting or exceeding a corresponding performance characteristic of the pre-trained machine learning model.

12. The apparatus of claim 11, wherein the performance characteristic is accuracy.

13. The apparatus of claim 1, wherein the processor is to distribute the selected sub-network to a compute device for execution.

14. The apparatus of claim 13, wherein the compute device is an Edge device within an Edge computing environment.

15. The apparatus of claim 13, wherein the processor is to select the sub-network such that an operational characteristic of the sub-network meets an operational requirement of the compute device.

16. The apparatus of claim 15, wherein the operational characteristic of the sub-network is a size of the sub-network and the operational requirement of the compute device is an amount of available memory of the compute device.

16. A non-transitory machine readable storage medium comprising instructions that, when executed, cause processor circuitry to at least:
access a pre-trained machine learning model;
create a super-network based on the pre-trained machine learning model;
create a plurality of subnetworks based on the super-network; and
search the plurality of subnetworks to select a subnetwork.

17. The non-transitory machine readable storage medium of claim 16, wherein the instructions to create the super-network, cause the processor circuitry to at least:
determine whether a layer of the pre-trained machine learning model is of a type that can be converted to an elastic layer; and
responsive to the determination that the layer is of a type that can be converted to the elastic layer, convert the layer to the elastic layer and add the elastic layer to the super-network.

18. The non-transitory machine readable storage medium of claim 17, wherein the elastic layer includes at least one variable property.

19. The non-transitory machine readable storage medium of claim 18, wherein the variable property is a variable number of channels of the elastic layer.

20-23. (canceled)

24. A method to modify pre-trained models and apply neural architecture search, the method comprising:
accessing a pre-trained machine learning model;
creating, by executing an instruction with at least one processor, a super-network based on the pre-trained machine learning model;
extracting, by executing an instruction with the at least one processor, a plurality of subnetworks from the super-network; and
searching the plurality of subnetworks to select a subnetwork.

25-31. (canceled)
